(19) United States
(12) Patent Application Publication
(10) Pub. No.: US 2012/0086148 A1
(43) Pub. Date: Apr. 12, 2012

(54) PROCESS FOR MOLDING A PLASTIC PART WITH AN INSERT HELD IN POSITION BY SUCTION, MOLDING DEVICE AND USE

(75) Inventors: Emmanuel Depierre, Thiescourt (FR); Romain Debailleul, Villers-sur-Coudun (FR); Pascal Lefevre, Viry Noureuil (FR)

(73) Assignee: SAINT-GOBAIN GLASS FRANCE, Courbevoie (FR)

(21) Appl. No.: 13/259,728

(22) PCT Filed: Mar. 29, 2010
(86) PCT No.: PCT/FR2010/050571

§ 371 Date: Dec. 6, 2011

(30) Foreign Application Priority Data
Mar. 30, 2009 (FR) 0951954
Jul. 31, 2009 (FR) 0955415

(51) Int. Cl. B29C 45/16; B29C 45/03

(52) U.S. Cl. 264/279; 425/470

(57) ABSTRACT

A process for molding a beading particularly on the periphery of a window or for molding a plastic window, in which a constituent plastic of said beading, or of said plastic window, respectively, is introduced into a molding cavity in which at least one insert, such as a trim, has been positioned beforehand, wherein said insert is held in position in said molding cavity, while said plastic is being introduced, by suction through a plurality of fine holes emerging on the internal surface of said molding cavity.

The present invention relates to the field of molding parts for the production of windows.

The present invention relates more particularly to the production of beadings on windows by molding or to the production of plastic windows (for example made of polycarbonate).

It relates more particularly to a process for molding a beading particularly on the periphery of a window or for molding a plastic window, in which a constituent plastic of said beading or of said plastic window, respectively, is introduced into a molding cavity in which one insert, such as a trim, has been positioned beforehand.

The prior art of international patent application WO 2007/018042 discloses a system for fastening a metal insert using an electromagnet for retaining the insert while the mold is being closed and during molding.

This system is difficult to manufacture and to use, as it requires the power supply for the electromagnet to be controlled.

The prior art also discloses, from European patent application EP 2 030 754 A1, a system for retaining an insert using a single suction hole, referenced 28 in FIG. 6 of that document.

Because this hole is a single hole, the cross section of its end that opens into the molding cavity is necessarily large—this hole is therefore a wide hole.

The prior art also discloses, from international patent application WO 2008/126505, a system for fastening a metal insert using several holes. However, the size of the holes is not indicated.

Now, the constituent plastic of the beading or of the window may penetrate via a hole or several holes when it is (or they are) wide.

Even if the molding cavity is designed for correctly receiving the insert and the hole(s) is (are) correctly positioned so that the insert is correctly held in position during injection of the plastic, in a production run of several hundred thousand parts or several million parts, there is a not insignificant probability that at least one insert has a defect in the suction zone or that at least one insert moves during the injection or even that at least one time the operator forgets to position the insert in the molding cavity before the injection is initiated.

When this occurs, while there is at least one wide suction hole, the injected plastic will penetrate into the wide hole and partially or even completely block it. To clean the hole, the production has to be shut down for a long period, which therefore will be very costly.

One object of the invention is to alleviate the drawbacks of the prior art by providing a system for retaining an insert, during molding of a beading or of a plastic window, which is simple, easy to manufacture and easy to use.

Another object is to provide a retention system which is reliable whatever the material of the insert (metal, metal alloy, plastic), while still being simple and easy to implement, even for large inserts.

The present invention thus relates in its widest context to a process for molding a beading particularly on the periphery of a window or for molding a plastic window as claimed in claim 1. According to this process, a constituent plastic of said beading, or of said plastic window, respectively, is introduced into a molding cavity in which at least one insert, such as a trim, has been positioned beforehand, and said insert is held in position in said molding cavity, while said plastic is being introduced, by suction through a plurality of fine holes emerging on the internal surface of said molding cavity.

Within the context of the present invention, a person skilled in the art will understand that the expression “fine holes” means holes which, if the insert has a defect in the suction zone or moves during injection and a fortiori in the absence of the insert from the molding cavity, prevent the plastic from penetrating into one of the holes, and a fortiori into several holes.

The inventors have discovered that the use of fine suction holes is particularly advantageous. Even though this complicates the design of the molding cavity, this slight difficulty is very considerably compensated for when the mold is used, since this design eliminates any risk of the suction holes being blocked.

Thus, with the invention, even if the insert were to have a defect in the suction zone or if the insert were to move during the injection, or even if the insert were to be absent from the molding cavity, in which case the injected plastic would move toward the holes and the window after injection molding would be nonconforming, the injected plastic cannot penetrate into the holes since they are fine, and therefore the production does not have to be stopped.

A simple test for knowing if holes are fine is to inject plastic into the molding cavity without the insert: if the injected plastic penetrates none of the holes, they are fine holes.

In one embodiment of the invention, said holes have, on the inner surface of the molding cavity, a width of between 0.2 and 1 mm, or even between 0.01 and 0.5 mm (the width here is the smallest dimension of the holes). In this embodiment, said holes preferably have, on the inner surface of the molding cavity, a length of between 5 and 30 mm.

The holes may be separated on the inner surface of the molding cavity by an edge-to-edge distance in two perpendicular directions of between 1 and 50 mm, or even between 2 and 30 mm, or even between 5 and 30 mm or even between 5 and 10 mm.

The holes on the inner surface of the molding cavity may be separated by an edge-to-edge distance in one direction of preferably between 5 and 30 mm, or even between 5 and 10 mm, and by an edge-to-edge distance in another direction, perpendicular to the first direction, of between 1 and 10 mm, or even between 2 and 5 mm, or even between 2.5 and 4.5 mm. Preferably, the holes have a noncircular cross section. Preferably, they are transversally elongate, that is to say in a direction perpendicular to the length of the holes. Thus, they are elongate along the length of the insert, i.e. elongate along the longest dimension of the insert.

Moreover, these holes preferably have a depth of between 2 and 30 mm, or even between 5 and 20 mm. This depth is measured starting from the surface of the bottom of the molding cavity in which the holes are produced.

The vacuum applied upstream of the holes may be around 50 to 100 kPa, or even around 70 to 95 kPa.

Preferably, the suction starts before the start of injection of the constituent plastic of said beading or of said plastic window respectively and the suction stops after the end of injection of the constituent plastic of said beading or of said plastic window respectively.

According to a most particular embodiment, the suction is reversed before the window is removed from the mold.

It is possible to produce the holes such that the total area of the holes on the internal surface of the molding cavity is of between 2 and 45%, preferably between 5 and 25%, of the adjacent area of the insert.

In one particular embodiment, a flexible sheet is furthermore held in place in said molding cavity during introduction of said plastic, by suction through a plurality of fine holes emerging on the internal surface of said molding cavity.

The present invention also relates to a molding device for implementing the molding process according to the invention, the device having a molding cavity that includes a plurality of fine holes emerging on its internal surface.

Preferably, this device includes, in front of the molding cavity, a vacuum chamber, said holes running into said vacuum chamber.

Preferably, said holes are empty holes—they are not obstructed, even partially, by a filter or a porous material.

Preferably, said holes are produced directly in the material of the surface of the molding cavity, with no seal.

In one embodiment of this device, at least one hole, and preferably all the holes, are produced by removing material on the edge of at least one lamella.

The bottom of the molding cavity therefore includes at least one lamella, and preferably several lamellae. The upper face of this (or these) lamella(e) thus forms (form) a portion of the internal face of the molding cavity, and especially a portion of the bottom of the recess that receives the insert.

The present invention also relates to the use of a plurality of holes for implementing the process according to the invention and to a process for manufacturing a mold for the implementation of the molding process according to the invention, in which the holes are produced by removing material on the edge of at least one lamella.

The expression “removing material on the edge of at least one lamella” should be understood, within the context of the present invention, to mean that the constituent material of the lamella is removed on a lateral face of the lamella so as to form a hole emerging on two other faces that are opposite each other. This hole is not circumferential but is similar, on the lateral face in which it is formed, to a slot.

To implement the invention, the slot is closed off by a post or by a lateral face of another lamella placed opposite the lateral face from which material was removed, so as therefore to form a circumferential hole.

Advantageously, the system according to the invention enables the insert to be reliably held in position during molding by means of simple elements that are easy to manufacture and to use, whatever the constituent material of said insert. The invention places no constraint on the choice of material of the insert and can thus be used with an insert which is completely or partly made of metal, such as aluminum, or a metal alloy, such as stainless steel, or of a plastic.

Also advantageously, the invention makes it easier to demold the assembly that incorporates the insert, by blowing from the insert, after the molding operation, via the holes that previously served for suction.

Also advantageously, the suction force is, or the suction/blowing forces are, exerted across the internal surface of the molding cavity via the fine holes. Thus, there is no movable element on the surface of the molding cavity. Therefore, it is easy to clean the mold as there is no seal in this insert retention zone.

Again advantageously, the retention system according to the invention is simple to use as it has no remanent effect, unlike the magnet retention systems. The retention system according to the invention is sufficient by itself: no system other than the fine-hole suction system, such as for example a system using a magnet, is necessary to hold the insert in position.

The present invention will be better understood on reading the detailed description below of nonlimiting embodiments in conjunction with the appended figures, in which:

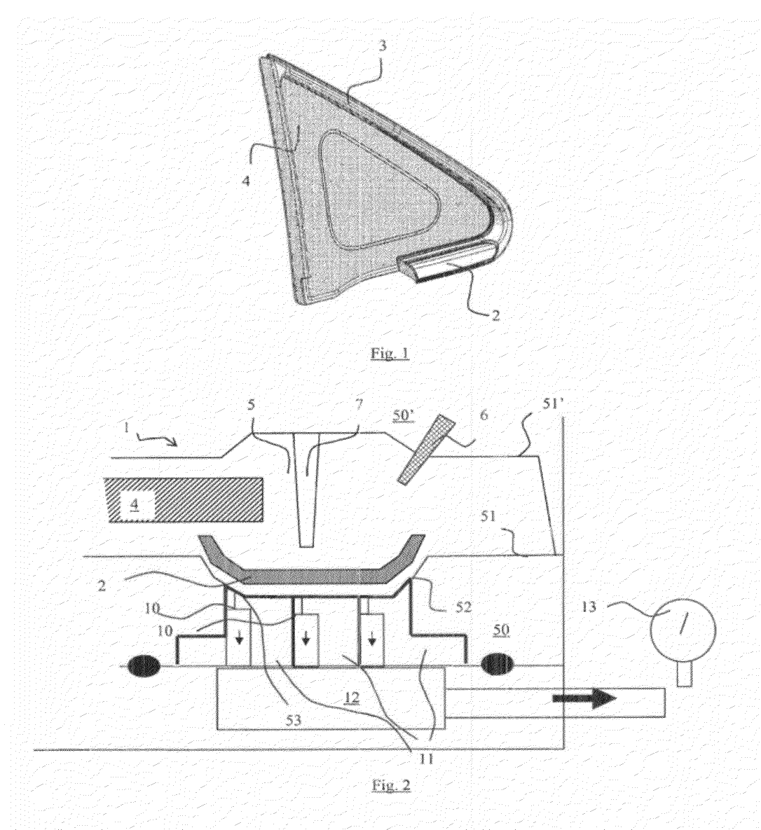

FIG. 1 illustrates a perspective view of a vehicle window having a trim fastened to the beading during the molding of said latter, the trim and the beading being illustrated in cross section in the bottom portion of the window;

FIG. 2 illustrates a sectional view of a molding cavity for implementing the invention with the insert not held in position;

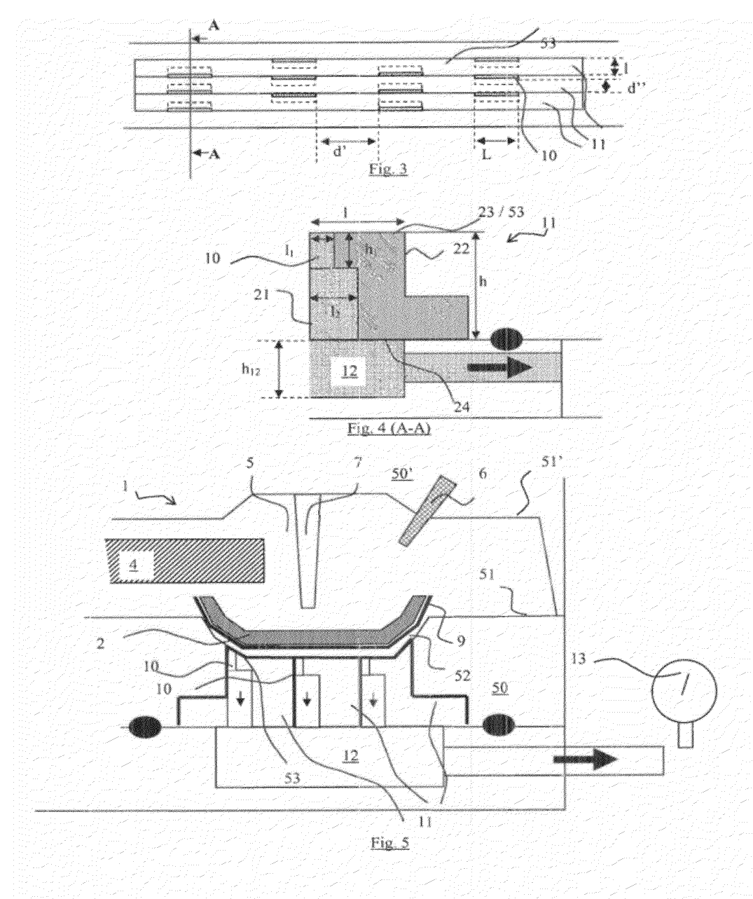

FIG. 3 illustrates a top view of the inner face of the molding cavity of FIG. 2;

FIG. 4 illustrates a partial view in section on AA of FIG. 3;

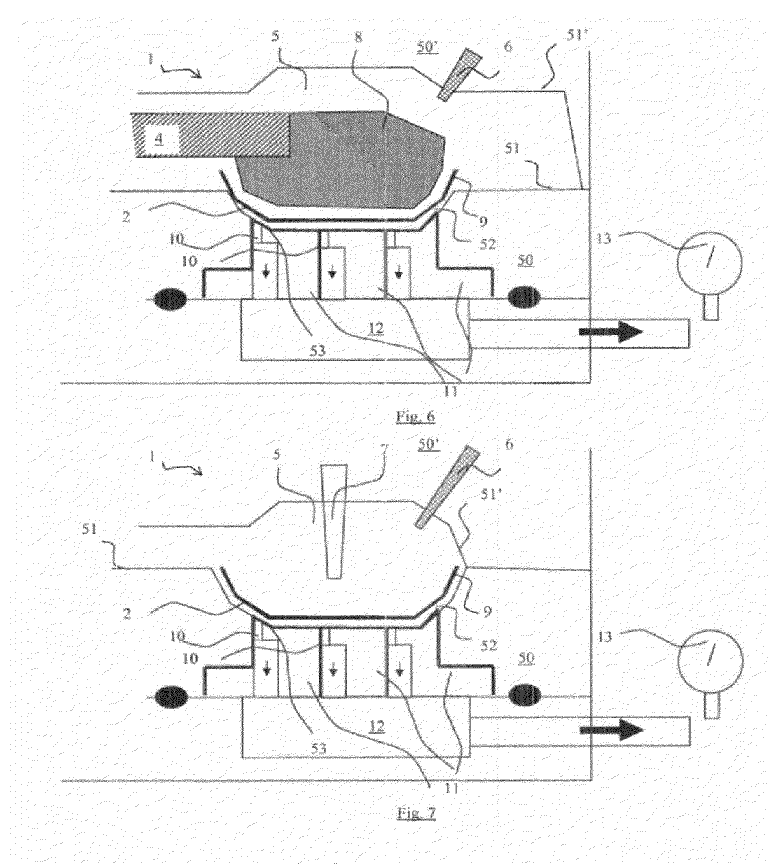

FIG. 5 illustrates a sectional view of the molding cavity of FIG. 2 for implementing a particular embodiment of the invention;

FIG. 6 illustrates a sectional view of the molding cavity of FIG. 5 for implementing a particular sub-embodiment of the invention; and

FIG. 7 illustrates a sectional view of a molding cavity for molding a plastic window according to the invention.

In these figures, the various elements have not been drawn to scale, and the background elements have not in general been shown, so as to make the figures easier to examine.

The present invention relates to an intermediate fastening device 1 for mounting an insert 2, such as a trim, on a portion of a beading 3, in particular on a portion of a beading fastened to the periphery of a window 4, and especially a vehicle window.

FIG. 1 illustrates a fixed window 4 of a motor vehicle, on the periphery of which a beading 3 made of a flexible polymer material is produced.

The constituent polymer material of the beading 3 may be a thermoplastic (PVC, TPE, etc.), a polyurethane or a synthetic rubber of the EPDM type, or any other suitable material.

The beading 3 was manufactured by implementing what is called an “encapsulation” manufacturing process as it includes a step of molding the beading 3 in a molding device between two molding elements, one molding element receiving the inner face of the window and one molding element receiving the outer face of the window, these two molding elements being closed off on each other during the molding step.

In FIG. 1, the beading 3 runs along the entire periphery of the window 4, but this beading could just as well be positioned only over a portion of the periphery of the window or over any portion of the window. The beading has been removed from the bottom front portion of the window in FIG. 1 so as to make it easier to understand the arrangement.

To improve the esthetic appearance of the window, one portion of the beading 3 visible from outside the vehicle is masked by an insert 2, which consists here of a trim and is placed here only in the bottom portion of the window, but could also be placed over the entire periphery of the window 4 and/or over any portion of the window.

The insert is prefabricated. It is manufactured, and possibly formed if it is rigid, before it is introduced into the injection mold in which the beading 3 is formed. The insert may be made of aluminum, an aluminum alloy, steel, especially stainless steel, plastic, and especially a plastic reinforced with fillers, such as for example silica-based mineral fillers or glass fibers. It may also be produced in several portions, possibly with different materials for at least two portions.

The insert may also be a decorative sheet made of a flexible material, such as for example a surface-colored or through-colored plastic sheet.

In one particular embodiment detailed below, the insert consists of two elements, a rigid support and a flexible sheet.

The window 4 may be a monolithic glazing panel, i.e. consisting of a single sheet of material, or it may be a composite glazing panel, i.e. consisting of several sheets of material between which at least one layer of adherent material is inserted in the case of laminated glazing panels, or at least one intermediate space is inserted in the case of multiple glazing (double glazing, triple glazing, etc.) panels. The sheet(s) may be made of inorganic material, especially glass, or organic material, especially a plastic.

In the case of a vehicle window, the glazing panel generally has, at least partially on its periphery, an ornamental strip (not illustrated here). This ornamental strip results in general from an enamel deposited on the inner face of the glazing panel or on an intermediate face in the case of composite glazing panels, but it may also result from partial and/or peripheral coloration of a sheet of material used, especially a sheet of organic material.

To manufacture the beading 3 by molding, the window 4 is positioned in one mold portion, here the lower mold portion 50 (as visible in FIG. 2), and then an upper mold portion 50′ is closed up on the lower mold portion so as to form a molding cavity 5 in the closed space between these two mold portions.

The perimeter of this molding cavity 5 is defined, on the one hand, by the inner face 51 of the lower mold portion 50 and, on the other hand, by the inner face 51′ of the upper mold portion 50′. The edge of the window 4 penetrates into the molding cavity so as to mold the beading 3 on the periphery of the window 4.

The constituent plastic of the beading 3 is injected into the molding cavity via at least one injection orifice 6.

Before the mold is closed and the constituent plastic of the beading 3 starts to be injected, an insert 2, such as a trim, is introduced into the lower mold portion 50, and more precisely in a recess 52 that has a similar shape, but in negative, to the shape of the insert.

The upper mold portion 50′ preferably includes, on its inner face 51′, at least one pin 7 for temporarily holding the insert 2 in place. Thus, when the upper mold portion 50′ is closed up onto the lower mold portion 50, the pin 7 will temporarily hold the insert 2 in position in the recess 52.

According to the invention, the insert 2 is held in position in said molding cavity 5 while the plastic of the beading 3 is injected, by suction through a plurality of fine holes 10, visible in FIGS. 2 to 4, which emerge on the internal surface of said molding cavity, and more precisely through a plurality of fine holes 10 emerging on the inner surface 51 of the lower mold portion 50.

The suction is applied via a plurality of holes 10 that have, on the inner surface 51, a noncircular cross section, namely one that is parallelepipedal and, more precisely, rectangular. The long direction of the rectangles is oriented along the length of the position of the insert in the molding cavity and the short direction of the rectangles is oriented along the length of the position of the insert in the molding cavity.

The simple arrows illustrate the orientation of the suction vacuum; however, it is also possible to use the holes 10 for blowing, so as to make demolding easier after the injection molding (the blowing being represented by an arrow in the opposite direction).

The holes 10 thus emerge both at one end on the inner surface 51 (and more precisely in the bottom 53 of the recess 52), on the one hand, and at another end in a vacuum chamber 12 on the other.

To hold the insert 2 in position once the mold has been closed, suction is created in the suction chamber 12 by a suction device and the vacuum is measured and controlled by the measurement/control system 13.

The height h₁₂ of the chamber depends on the desired vacuum and its width and length depend on the dimensions of the insert.

Firstly, the suction extracts some of the air present in the molding cavity 5 and then the insert 2 is rapidly sucked down so as to press against the bottom 53.

In this position (not illustrated), that face of the insert which is oriented toward the bottom 53 will therefore essentially close off the holes 10.

Once the insert 2 is pressed against the bottom 53, the injection of material via the injection orifice 6 may then commence.

The blocking of the holes 10 by the insert prevents the plastic injected into the molding cavity 5 via the injection orifice 6 from penetrating into the holes 10. There is therefore no plastic penetrating into the suction chamber 12.

Once the injection has been completed, it is then possible to make it easier to open the mold and to demold the window by reversing the suction, by blowing in the opposite direction to the suction.

In order for the suction force, or possibly even the blowing force, to operate correctly across the internal surface of the molding cavity without the constituent material of the beading penetrating into the holes, it is important for them to be fine holes.

However, with certain mold manufacturing processes it may prove difficult to achieve the desired precision in making the holes 10.

In the embodiment shown in FIGS. 2 to 4, the holes 10 are of rectangular cross section and were produced by removing material on the edges of lamellae 11.

Each removal has, in horizontal section, a U-shape and is carried out on one or both lateral faces 21, 22 of each lamella so as to extend from its upper face 23 to its lower face 24. The lamella 11 illustrated in FIG. 4 has no removal on its lateral face 22 on the right since this is the lamella furthest to the right in the set of lamellae. Removing material on both lateral faces of a lamella enables the alignment of the holes to be varied and thus makes it easier to distribute the holes, while reducing the number of lamellae.

These lamellae are then placed side by side in order for their upper face 23 to form the bottom 53.

Each lamella 11 has a width l of around 3 to 5 millimeters and a height h of around 15 to 50 mm.

The holes may be separated on the inner surface of the molding cavity by an edge-to-edge distance in two perpendicular directions of between 1 and 50 mm, or even between 2 and 30 mm.

The distance d′ between the holes 10 along the length of the lamellae is around 5 to 10 mm and the distance d″ between the holes 10 along the width of the lamellae is around 2.5 to 4.5 mm.

The width l₁ of the holes 10 made in the bottom 53 of the recess of the internal face 54 of the molding cavity by removal of material may be much smaller than the diameter of the holes, which are for example produced by drilling.

The table below gives the recommended width dimension l₁ of the holes according to the constituent material of the beading 3 (or that of the plastic window):

| | Examples of materials | Recommended |
|---|---|---|
| Material family | in the family | width l₁ (mm) |
| PVC | SUNPREN, ROTTOLIN, | 0.05 ± 0.005 |
| | RIKKEN, TECKNOR | |
| | APEX | |
| TPU | PELLETHANE | 0.04 ± 0.005 |
| TPE | KRAIBURG, SARLINK, | 0.03 ± 0.005 |
| | SANTOPRENE, TOSI | |
| PP | BOREALYS, | 0.02 ± 0.005 |
| | SCHULMANN | |
| PU-RIM | BASF, BAYER | 0.01 ± 0.005 |
| PC | LEXAN, MAKROLON | 0.03 ± 0.005 |

The holes 10 may then be larger in the direction of the vacuum chamber 12 and may have a width l₂ of around 1 mm over the rest of the height of the lamella.

Thus, the width l₁ may be produced over a height h₁ of around 0.5 to 10 mm, or even 0.5 to 5 mm or even 1 to 5 mm.

The length L of the holes 10 is around 5 to 30 mm.

Here, to make it easier to manufacture the device, the lower face of the lamellae, which is placed opposite the upper face having the holes, constitutes the roof of the vacuum chamber 12.

FIG. 2 illustrates the moment when, in respect of the second embodiment, the mold is completely closed and the suction retention system according to the invention is going to be actuated. In this FIG. 2, the trim is illustrated at a certain distance from the bottom 53 of the recess 52 so as to clearly show that the suction retention system is not yet activated. In practice, due to the effect of gravity, the trim would rest in the bottom 53 of the recess 52.

According to the invention, there is no particular provision in the internal surface zone of the molding cavity that receives the insert other than the production of the holes 10. For implementing the invention, there is therefore no seal or any other sealing element in the internal surface zone of the molding cavity that receives the insert.

According to the invention, the suction is such that the material injected via the injection orifice cannot slip between the insert 2 and the bottom 53 of the molding cavity. Thus, the trim has no plastic on its visible face after molding, that is to say on its face turned toward the bottom 53 during molding.

In one particular embodiment, illustrated in FIG. 5, the insert consists of two elements: a rigid support, similar to the trim described above, and a flexible sheet 9 which is introduced into the molding cavity between the rigid support and the bottom 53.

During implementation of the invention, the rigid support is held in position by the pin 7 against the flexible sheet (or is held in position by clamping on the window 4) and the flexible sheet is held in position against the bottom 53 by the suction, at least until the material injected into the molding cavity holds both the rigid support and the flexible sheet in position. There is no material of the beading between the rigid support and the flexible sheet on the end-product—the rigid support and the flexible sheet 9 each act as an insert within the meaning of the invention.

In a sub-embodiment of the previous embodiment, illustrated in FIG. 6, the rigid support 8 is preencapsulated on the window 4 (i.e. the rigid support 8 is manufactured beforehand by encapsulation in another mold) and the flexible sheet 9 is held in place against the bottom 53 by the suction, at least until the material injected into the molding cavity holds both the rigid support and the flexible sheet in place. In this configuration, there is material of the beading between the rigid support 8 and the flexible sheet 9 on the end-product—it is the flexible sheet 9 that acts as insert within the meaning of the invention.

It is also possible to implement the invention for molding a plastic window, in which a constituent plastic of said plastic window is introduced into a molding cavity in which at least one insert, such as a trim, has been positioned beforehand.

In this case, the insert is then directly overmolded onto the surface of said window.

FIG. 7 thus illustrates the process according to the invention for molding a plastic window, in which the constituent plastic of said plastic window is introduced into the molding cavity 5 which is defined, on one side, by the inner face 51 of the lower mold portion 50 and, on the other side, by the inner face 51′ of the upper mold portion 50′. The constituent plastic of the plastic window is injected into the molding cavity via at least one injection orifice 6. Before the mold is closed and the constituent plastic of the plastic window starts to be injected, an insert 2, such as a trim (or here a flexible sheet 9), is introduced into the lower mold portion 50, and more precisely in a recess 52 which has a similar shape, but in negative, to the shape of the insert as desired on the window.

As described above, the upper mold portion 50′ preferably includes, on its inner face 51′, at least one pin 7 for temporarily holding the insert 2 in place. Thus, upon closing the upper mold portion 50′ onto the lower mold portion 50, the pin 7 will temporarily hold the insert 2 in position in the recess 52.

According to the invention, the insert 2 is held in position in said molding cavity 5, during injection of the plastic of the plastic window, by suction through a plurality of fine holes 10 that emerge on the internal surface of said molding cavity, and more precisely through a plurality of fine holes 10 emerging on the inner surface 51 of the lower mold portion 50, as described above.

The present invention has been described in the foregoing by way of example. It should be understood that a person skilled in the art is capable of producing various embodiments of the invention without thereby departing from the scope of the patent as defined by the claims.

In particular, although the molding illustrated here is a vertical molding operation with the movable mold portion moving vertically with respect to the fixed mold portion, the invention may also be implemented for horizontal molding or for molding in any other orientation.

1. A process for molding a beading particularly on the periphery of a window or for molding a plastic window, in which a constituent plastic of said beading, or of said plastic window, respectively, is introduced into a molding cavity in which at least one insert, such as a trim, has been positioned beforehand, wherein said insert is held in position in said molding cavity, while said plastic is being introduced, by suction through a plurality of fine holes emerging on the internal surface of said molding cavity.

2. The molding process as claimed in claim 1, wherein said holes have, on the inner surface of the molding cavity, a width of between 0.2 and 1 mm, or even between 0.01 and 0.5 mm.

3. The molding process as claimed in claim 1, wherein said holes are separated on the inner surface of the molding cavity by an edge-to-edge distance in two perpendicular directions of between 1 and 50 mm, or even between 2 and 30 mm.

4. The molding process as claimed in claim 1, wherein said holes have a depth of between 2 and 30 mm, or even between 5 and 20 mm.

5. The molding process as claimed in claim 1, wherein the vacuum applied upstream of the holes is around 50 to 100 kPa, or even around 70 to 95 kPa.

6. The molding process as claimed in claim 1, wherein the suction starts before the start of injection of the constituent plastic of said beading or of said plastic window respectively and the suction stops after the end of injection of the constituent plastic of said beading or of said plastic window respectively.

7. The molding process as claimed in claim 1, wherein the suction is reversed before the window is removed from the mold.

8. The molding process as claimed in claim 1, wherein the total area of the holes on the internal surface of the molding cavity is of between 2 and 45%, preferably between 5 and 25%, of the adjacent area of the insert.

9. The molding process as claimed in claim 1, wherein a flexible sheet is furthermore held in place in said molding cavity during introduction of said plastic, by suction through a plurality of fine holes emerging on the internal surface of said molding cavity.

10. A molding device for implementing the molding process as claimed in claim 1, wherein it has a molding cavity that includes a plurality of fine holes emerging on its internal surface.

11. The molding device as claimed in claim 10, wherein it includes, in front of the molding cavity, a vacuum chamber, said holes running into said vacuum chamber.

12. The molding device as claimed in claim 10, wherein said holes are empty holes.

13. The molding device as claimed in claim 10, wherein said holes are produced directly in the material of the surface of the molding cavity.

14. The molding device as claimed in claim 10, wherein at least one hole, and preferably all the holes, are produced by removing material on the edge of at least one lamella.

15. A process for manufacturing a mold for the implementation of the molding process as claimed in claim 1, in which the holes are produced by removing material on the edge of at least one lamella, an upper face of the at least one lamella forming a portion of the internal face of the molding cavity, and especially a portion of the bottom of the recess that receives the insert.
